(19) United States
(12) Patent Application Publication
(10) Pub. No.: US 2011/0139185 A1
(43) Pub. Date: Jun. 16, 2011

(54) Systems and Methods for Phasing Multiple Impulse Cleaning Devices

(75) Inventors: David Michael Chapin, Kansas City, MO (US); Anthony John Dean, Scotia, NY (US)

(73) Assignee: GENERAL ELECTRIC COMPANY, Schenectady, NY (US)

(21) Appl. No.: 12/639,560

(22) Filed: Dec. 16, 2009

(51) Int. Cl. B08B 7/00

(52) U.S. Cl. 134/19; 134/184

(57) ABSTRACT

Embodiments provide systems and methods for removing debris from a surface. A system can include a first impulse cleaning device and a second impulse cleaning device, each impulse cleaning device generating shock waves directed to a surface to be cleaned, wherein the first impulse cleaning device and the second impulse cleaning device are oriented such that the respective shock waves intersect at or proximate the surface. The system can further include a controller in operable communication with the first impulse cleaning device and the second impulse cleaning device, wherein the controller is configured to selectively cause phased operation of the first impulse cleaning device and the second impulse cleaning device such that the phased operation selectively controls the location of the intersection of the respective shock waves.

### FIELD OF THE INVENTION

Embodiments of the invention relate generally to industrial cleaning devices, and more specifically relate to systems and methods for phasing multiple impulse cleaning devices.

### BACKGROUND OF THE INVENTION

Industrial boilers operate by using a heat source to create steam from water or another working fluid, which can then be used to drive a turbine in order to supply power. The heat source may be a combustor that burns a fuel in order to generate heat, which is then transferred into the working fluid via a heat exchanger. Burning the fuel may generate residues that can be left behind on the surface of the combustor or heat exchanger. Such residues of soot, ash, slag, or dust on heat exchanger surfaces can inhibit the transfer of heat and therefore decrease the efficiency of the system (e.g., of the boiler). Periodic removal of such built-up deposits maintains the efficiency of such boiler systems.

Pressurized steam, water jets, acoustic waves, and mechanical hammering have been used to remove built-up deposits. These known cleaning systems can be costly to maintain, the effectiveness of these systems varies, and some may require system downtime to perform cleaning.

A pulsed detonation combustion or impulse cleaning system has recently been used in an attempt to remove built-up deposits. Pulsed detonation combustion events create strong impulse waves (also referred to herein as “shock waves”) that remove the built-up deposits and accumulated debris from the heat exchanger surfaces.

It is desirable to further improve impulse cleaning systems.

### BRIEF DESCRIPTION OF THE INVENTION

Embodiments of the invention can address some or all of the needs addressed above. According to one embodiment, a system for removing debris from a surface is provided. The system can include a first impulse cleaning device and a second impulse cleaning device, each impulse cleaning device generating shock waves directed at a surface to be cleaned, wherein the first impulse cleaning device and the second impulse cleaning device are oriented such that the respective shock waves intersect at or proximate the surface. The system can further include a controller in operable communication with the first impulse cleaning device and the second impulse cleaning device, wherein the controller is configured to selectively cause phased operation of the first impulse cleaning device and the second impulse cleaning device such that the phased operation selectively controls the location of the intersection of the respective shock waves.

According to another embodiment, a method for removing debris from a surface is provided. The method can include delivering a desired quantity of an oxidizer to a first impulse cleaning device and a desired quantity of an oxidizer to a second impulse cleaning device; and delivering a desired quantity of fuel flow to the first impulse cleaning device and a desired quantity of fuel flow to the second impulse cleaning device. The method can further include igniting the first impulse cleaning device and the second impulse cleaning device based at least in part on a phasing profile, thus causing phased operation of the first impulse cleaning device and the second impulse cleaning device such that the phased operation selectively controls the location of the intersection of corresponding shock waves produced by the first impulse cleaning device and the second impulse cleaning device; and directing the corresponding shock waves toward a surface.

According to yet another embodiment, a system for removing debris from a surface is provided. The system can include multiple impulse cleaning devices, wherein at least two of the impulse cleaning devices are oriented such that respective shock waves produced thereby intersect at or proximate a surface to be cleaned. The system can further include a controller in operable communication with the impulse cleaning devices. The controller can be operable to: operate the impulse cleaning devices based at least in part on a phasing profile, thus causing phased operation of at least two of the impulse cleaning devices such that the phased operation selectively controls the location of the intersection of respective shock waves produced by the first impulse cleaning device and the second impulse cleaning device.

Other embodiments, aspects, and features will become apparent to those skilled in the art from the following detailed description, the accompanying drawings, and the appended claims.

### BRIEF DESCRIPTION OF THE DRAWINGS

Reference will now be made to the accompanying drawings, which are not necessarily drawn to scale, and wherein:

FIG. 1 is a schematic representation of an impulse cleaning system, according to one example embodiment.

FIG. 2 is a schematic representation of impulse cleaning device orientations and corresponding shock wave propagation, according to one example embodiment.

FIG. 3 is a schematic representation of impulse cleaning device orientations and corresponding shock wave propagation, according to one example embodiment.

FIG. 4 is a schematic representation of impulse cleaning device orientations and corresponding shock wave propagation, according to one example embodiment.

FIG. 5 is a flowchart representation of an example method for controlling multiple impulse cleaning devices, according to one example embodiment.

FIG. 6 is a block diagram illustrating an example controller, according to an embodiment of the invention.

### DETAILED DESCRIPTION OF THE INVENTION

Illustrative embodiments of the invention now will be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

An industrial boiler is described herein as an example vessel having a surface to be cleaned by the impulse cleaning system embodiments described herein. However, it is appreciated that the impulse cleaning system and methods described herein may be used with any other surface of any vessel, machine, or other equipment and can provide cleaning on a variety of different surfaces which may experience fouling or accumulation of debris. Accordingly, while vessel and/or surface are used herein when describing example embodiments, the two terms are used interchangeably to generally refer to any surface to be cleaned. Examples of surfaces which may be cleaned using the systems and techniques described herein include, but are not limited to, surfaces of vessels used in cement production, waste-to-energy plants, and coal-fired energy facilities, as well as reactors in coal gasification plants, and the like.

Soot or other buildup on heat exchanger surfaces in industrial boilers can cause losses in the overall efficiency of the boiler due to a reduction in the amount of heat that is actually transferred into a working fluid. This is often reflected by an increase in the exhaust gas temperature from the process, as well as an increase in the fuel-burn rate required to maintain steam production and a given energy output. Traditionally, the complete removal of buildup from the heat exchanger surfaces requires the boiler to be shut down while a cleaning process is performed. Some known online cleaning techniques generally have high maintenance costs or incomplete cleaning results.

In embodiments described in more detail herein, an impulse cleaning system located external to the boiler is used to generate a series of shockwaves that are directed into a fouled portion of the boiler. The impulse cleaning system includes at least two impulse cleaning devices oriented to cause the impulse waves (also referred to interchangeably herein as “shock waves”) propagating therefrom to intersect at a point within the boiler. Upon intersection, cleaning energy of the impulse waves are enhanced due to the additive nature of the intersecting waves at or near the point of intersection. The resulting impulse waves impact boiler surfaces and loosen buildup from the surfaces. The loosened debris is free to fall to the bottom of the boiler and then may exit the boiler through hoppers. Selectively phasing the operation of the two (or more) impulse cleaning devices by a controller and controller logic allows controlling the location of the intersection of the corresponding shock waves, and therefore controlling the area of the boiler receiving the increased cleaning energy.

As used herein, the term “impulse cleaning device” can be used interchangeably with shock cleaning device to generally refer to any device operable to create shock waves (e.g., a system that produces both a pressure rise and velocity increase therein). The term “impulse cleaning device” is not intended to be limited to pulsed detonation devices or other detonative devices. Although one example embodiment described herein refers to a pulsed detonation system including an oxidizer and an ignition device for igniting combustible fuel therein to generate shock waves, this embodiment is illustrative and not intended to be limiting.

More specifically, in one embodiment, a system can include a first impulse cleaning device and a second impulse cleaning device. According to this embodiment, each impulse cleaning device includes a combustion chamber in which combustible fuel and air (or other oxidizer) are mixed and ignited to cause combustion and corresponding shock waves directed from the combustion chamber into the vessel. The first device and the second device are positioned so the shock waves created by the respective impulse cleaning devices intersect within the vessel (e.g., boiler) to be cleaned. In one embodiment, a controller in operable communication with each of the impulse cleaning devices executes controller logic to cause phased operation (e.g., detonation) of the impulse cleaning devices. Phased detonation allows to selectively control the point of shock wave intersection, and thus the area receiving the enhanced cleaning energy created by the intersection of the two shock waves. According to various embodiments, a phasing profile or profiles can be implemented that allow selectively manipulating the phased detonation of the first and the second impulse cleaning devices to allow moving the point of shock wave intersection, thus moving the area of the vessel exposed to the enhanced cleaning energy.

For example, in one embodiment, two impulse cleaning devices are oriented in an opposed orientation, such that each extends at least partially into the vessel and the shock waves produced thereby propagate along approximately the same axis in a direction toward each other. Therefore, the shock wave intersection point will be at some intermediate point between the two opposed impulse cleaning devices and within the vessel. A phasing profile, which generally refers to the attributes that control or otherwise relate to the relative timing of ignition between two or more impulse cleaning devices, and/or the location of intersection of at least two shock waves, can be defined that causes delayed ignition by one of the two impulse cleaning devices so the point of intersection is closer to the delayed impulse cleaning device (having had more time to travel from the impulse cleaning device ignited first). In various embodiments, the delay can be altered with successive ignition events to move the shock wave intersection point closer to (and/or farther from) one of the impulse cleaning devices. A phasing profile altering the ignition timing allows moving the enhanced cleansing area within the vessel. It is appreciated that other operation parameters, such as fuel flow and/or air flow, may also be indicated by the phasing profile and adjusted to alter the shock wave intersection point.

According to one embodiment, the impulse cleaning system can be operated in a repeating mode to produce multiple detonations or quasi-detonations within the device. These detonations or quasi-detonations form a pulse of energy in the form of a shock wave that can be used for cleaning built-up deposits and accumulated debris from surfaces of a boiler vessel. A “detonation” is a supersonic (or may be subsonic) combustion event in which a shock wave is coupled to a combustion zone. In this embodiment, the shock wave is sustained by the energy released from the combustion zone, resulting in combustion products at a higher pressure than the combustion reactants. For simplicity, the term “detonation” as used herein will be meant to include both detonations and quasi-detonations. A “quasi-detonation” is a supersonic turbulent combustion process that produces a pressure rise and velocity increase higher than a pressure rise and velocity increase produced by a subsonic deflagration wave.

Various example impulse cleaning systems, some of which will be discussed in further detail below, include an ignition device for igniting a fuel/oxidizer mixture, and a detonation chamber or zone in which pressure wave fronts initiated by the combustion coalesce to produce a detonation wave. Each detonation or quasi-detonation is initiated either by an external ignition source, such as a spark discharge, laser pulse, heat source, or plasma igniter, or by gas dynamic processes such as shock focusing, auto ignition or an existing detonation wave from another source (cross-fire ignition). The detonation chamber geometry allows the pressure increase behind the detonation wave to drive the detonation wave and also to blow the combustion products out of the impulse cleaning system.

Various chamber geometries can support detonation formation, including round chambers, tubes, resonating cavities, and annular chambers. Such chambers may be of constant or varying cross-section, both in area and shape. Example chambers include cylindrical tubes and tubes having polygonal cross-sections, such as, for example, hexagonal tubes or including obstacles to promote detonation. As used herein, “downstream” refers to a direction of flow of at least one of fuel or oxidizer.

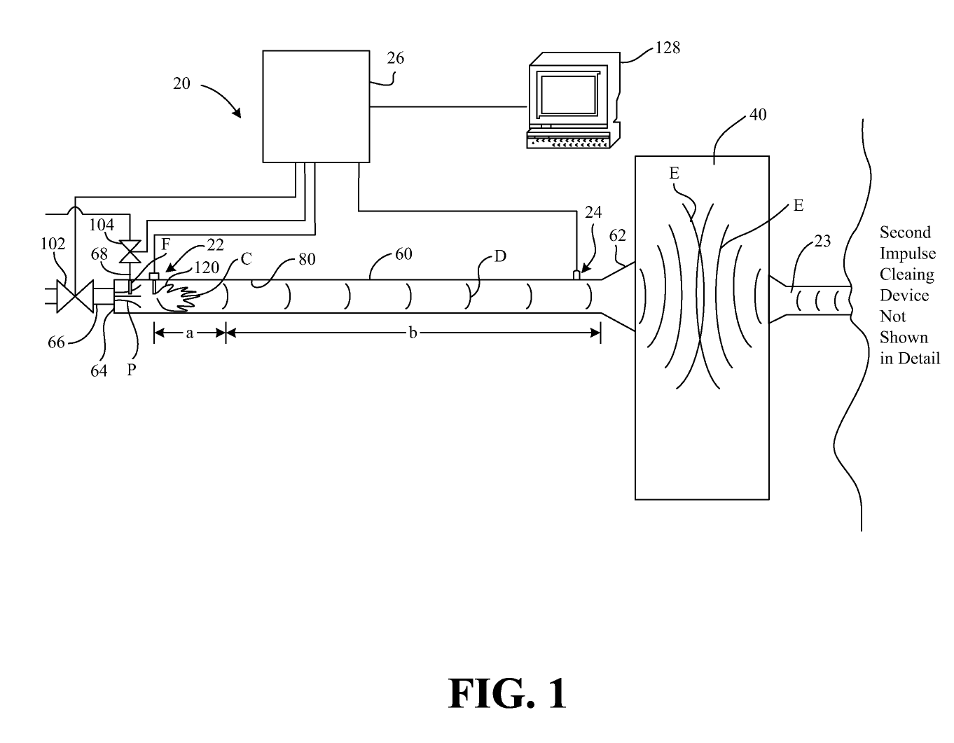

One embodiment of an example impulse cleaning system 20 suitable for use with an industrial boiler (or any other vessel) is illustrated schematically in FIG. 1. The impulse cleaning system 20, according to one aspect of the invention, includes at least a first impulse cleaning device 22, a second impulse cleaning device 23, and a monitor/controller 26. An optional sensor 24 associated with the impulse cleaning device may also be included, such as may be used to monitor the operation of the impulse cleaning devices 22, 23 and/or provide feedback to the controller to further alter subsequent control of the impulse cleaning devices 22, 23. The impulse cleaning system 20 is constructed and mounted such that it can direct shock waves (also referred to interchangeably herein as “cleaning pulses”) of energy E into a vessel 40 (e.g., an interior wall of a boiler vessel). In one embodiment, the open ends of the impulse cleaning devices 22, 23 are inserted into the vessel 40 such that they are in fluid communication with the interior space of the vessel 40 and one or more surfaces of components within the vessel 40 (e.g., multiple heat exchanger tubes and/or other surfaces, walls, etc. within a boiler). Though, in other embodiments, one or more of the cleaning devices may be completely exterior of the vessel 40. Although not illustrated in detail in FIG. 1, the second impulse cleaning device 23 is configured in the same or similar manner as the first impulse cleaning device 22, but positioned in an opposed and/or complementary orientation relative to the first impulse cleaning device 22 and the vessel 40. However, for simplicity, the remainder of the description of the cleaning devices will be provided with reference to the first impulse cleaning device 22.

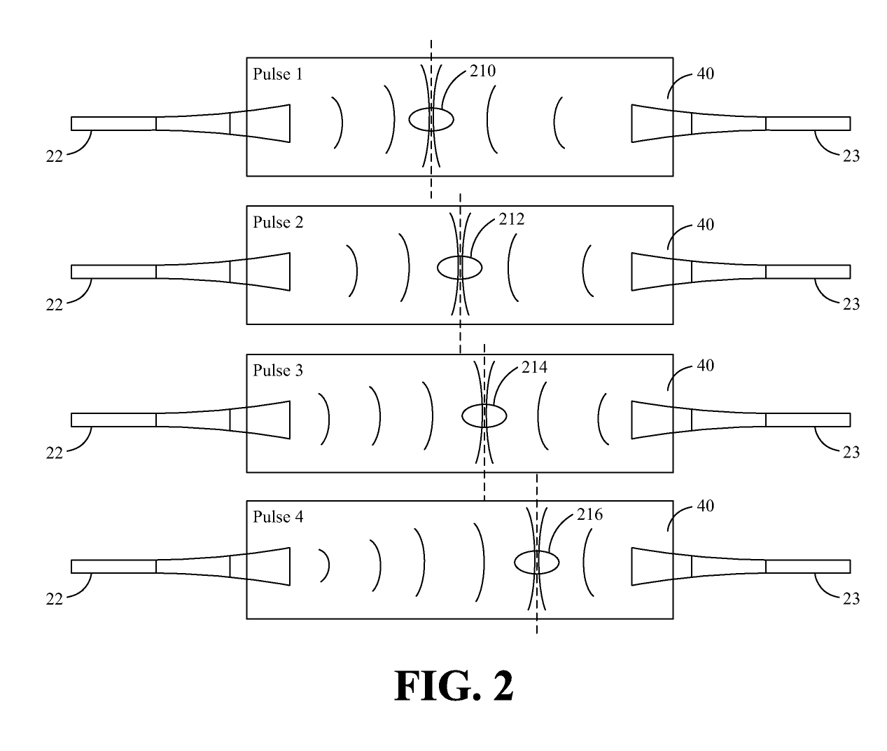

In one embodiment, the vessel 40 may include multiple tubes that are located in the boiler vessel and supported by a wall. The impulse cleaning devices 22, 23 are oriented to direct the cleaning pulses toward or near the wall of the vessel 40 and/or near the multiple tubes (e.g., heat exchanger tubes) within the vessel 40. The cleaning pulses of energy E can also be directed at or proximate other surfaces within and/or exterior to the vessel 40. The wall and tubes of a boiler tend to have soot or other buildup resulting from a combustion process in the boiler vessel that can cause losses in the overall system efficiency due to a reduction in the amount of heat that is actually transferred into a working fluid flowing through the tubes. For example, as is shown in FIG. 2, which is described in more detail below, a phasing profile can cause the location of the intersection of cleaning pulses from two impulse cleaning devices 22, 23 to move along the length of a tube or other surface (assuming a tube or other surface lies along the length of the vessel 40).

According to this embodiment, the impulse cleaning device 22 has a tubular body 60 that extends longitudinally with an open “horn” end 62 inserted into, or otherwise in fluid communication with, the vessel 40 (e.g., boiler) to be cleaned. The body 60 has an opposite closed head end 64 and air inlet ports 66 and a fuel inlet port 68. The body 60 defines a combustion chamber 80 that has a deflagration zone “a” and a detonation zone “b.” The impulse cleaning device 22 can be mounted to the vessel 40 using a bracket or other suitable mounting mechanism.

The head end 64 of the impulse cleaning device 22 of this embodiment has its air inlet ports 66 connected to a source of air that can be provided under pressure through a valve 102 to deliver a flow of air P to the combustion chamber 80. This air source is used to fill and purge the combustion chamber 80, and also provides air to serve as an oxidizer for the combustion of the fuel. The air inlet ports 66 may be connected to a facility air source such as an air compressor (not shown). The same or different air source can be connected to inlet ports of the second impulse cleaning device 23.

In this embodiment, the fuel inlet port 68 is located at the head end 64 of the impulse cleaning device 22 and extends in a direction transversely relative to the air inlet ports 66. The fuel inlet port 68 is connected to a supply a flow of fuel F to the combustion chamber 80 through valve 104. The fuel F will be burned within the combustion chamber 80. The fuel F that is supplied to the combustion chamber 80 is mixed with the flow of air P. The same or different fuel source can be connected to the inlet ports of the second impulse cleaning device 23.

The mixing of the fuel F and air P may be enhanced by the relative arrangement of air inlet ports 66 and the fuel inlet port 68. For example, a plurality of fuel inlet ports 68 may be provided around the periphery of the combustion chamber 80. By placing the fuel inlet port or ports 68 at a location such that fuel F is injected into regions of high turbulence generated by the flow of air P, the fuel and air may be more rapidly mixed to provide a more readily detonatable fuel/air mixture. As with the air inlet ports 66, the fuel inlet ports 68 may be disposed at a variety of axial and circumferential positions. The fuel inlet ports 68 may be aligned to extend in a purely radial direction, or may be canted axially or circumferentially with respect to the radial direction.

Fuel F is supplied to the fuel inlet ports 68 through the valve 104 that controls when fuel is allowed into the combustion chamber 80 of the impulse cleaning device 22. The valve 104 may be disposed within the fuel inlet port 68, or may be disposed upstream in a supply line that is connected to the fuel inlet port. The valve 104 may be a solenoid valve and may be controlled electronically by the controller 26 to open and close in order to regulate the flow of fuel F into the combustion chamber 80. The controller 26 may also electronically control the valve 102 and the flow of air P to the combustion chamber 80.

In one embodiment, any of the fuel source, the air source, the air inlet ports 66, the air valves 102, the fuel inlet ports 68, and/or the fuel valves 104 for the first and the second impulse cleaning devices 22, 23 can be in electrical communication with the controller 26 for monitoring and recording the fuel flow and air flow to each of the combustors. Accordingly, the controller 26 and corresponding controller logic may optionally be programmed to consider the fuel and/or air flow when controlling the operation of each of the first and the second impulse cleaning devices 22, 23. Moreover, the controller 26 may further be operative to consider the fuel and/or air flow when adjusting phasing profiles and/or controlling the phased detonation of the first and the second impulse cleaning devices 22, 23.

Also as illustrated in FIG. 1, an ignition device 120 is located near the head end 64 of the impulse cleaning device 22 in this embodiment. In the illustrated embodiment, the ignition device 120 ignites the fuel/air mixture to create combustion C in the deflagration zone a. The ignition device 120 may take various forms. In particular, the ignition device 120 need not produce immediate detonation of the fuel/air mixture in every embodiment. However, the ignition device 120 provides sufficient energy for ignition that allows the combustion of the fuel/air mixture which can transition to a supersonic shock wave D, within the detonation zone b of the combustion chamber 80. The ignition device 120 may be connected to the controller 26 to operate the ignition device at desired or periodic times. As further described herein with reference to FIGS. 2-5, the controller and corresponding controller logic may be programmed to implement phased ignition, and thus detonation, of the impulse cleaning devices 22, 23 to allow manipulating the point of shock wave intersection and the delivery of enhanced cleaning energy.

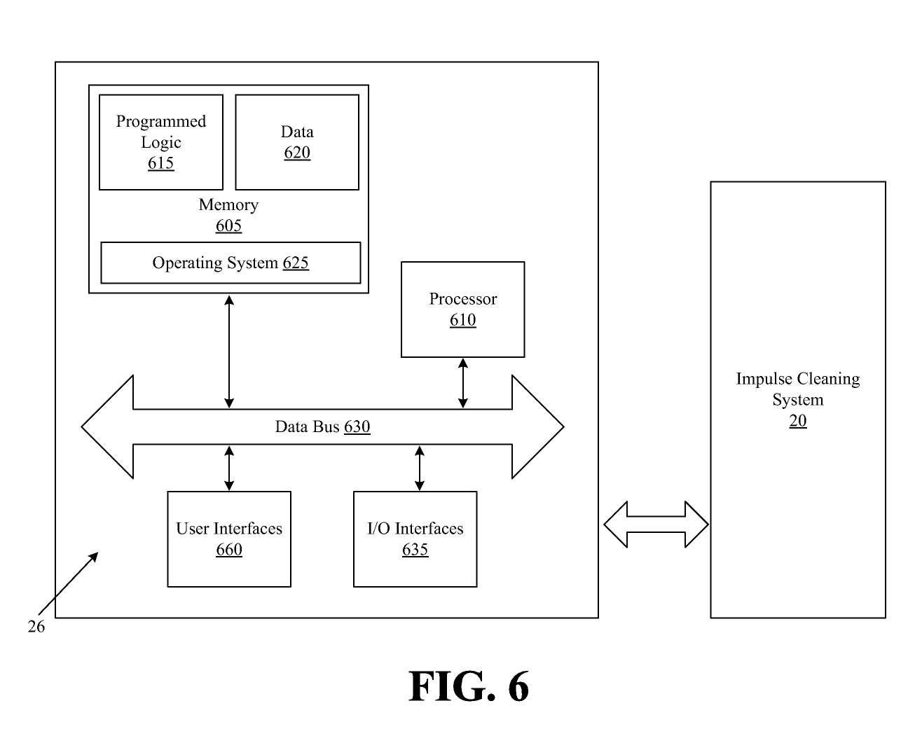

The controller 26 may be of any suitable type or combination of components to control the timing and operation of various systems, such as the valves 102, 104 and ignition device 120. As used herein, the term controller 26 is not limited to just those integrated circuits generally referred to in the art as a controller, but broadly refers to a master networked computer, processor, a microprocessor, a microcontroller, a programmable logic controller, an application-specific integrated circuit, other programmable circuits suitable for such purposes and software or any suitable combination thereof. An example controller 26 is described in more detail herein with reference to FIG. 6.

The impulse cleaning device 22, constructed according to one aspect as illustrated in FIG. 1, includes the elongate body 60 defining the combustion chamber 80 that extends from the head end 64 to the horn end 62. Combustion of the fuel/air mixture takes place within the combustion chamber 80. In general, the combustion C will progress from the ignition device 120 through the mixture that is within the combustion chamber 80. FIG. 1 illustrates a cross-section of body 60 in the shape of a substantially round cylinder having a constant cross-sectional area. Other configurations of the body 60 and combustion chamber 80 are possible. The horn end 62 is formed as a diverging chamber that is connected directly to the body 60 of the impulse cleaning device 22. In other embodiments, the end of the elongate body 60 may not include a horn end, but instead have the same or similar diameter and cross-sectional shape as the chamber, or may have any other configuration as desired. Although the horn end 62 need not be in direct contact with the impulse cleaning device 22, the combustion chamber 80 of the impulse cleaning device is at least in fluid flow communication with the diverging chamber of the horn end 62.

The body 60 may contain a number of obstacles (not shown) in the combustion chamber 80 disposed at various locations along the length of the body. The obstacles are used to enhance the combustion as it progresses along the length of the body 60, and to accelerate the combustion front C into a supersonic shock wave D before the combustion front reaches the horn end 62 at the downstream end of the body. The body 60 and obstacles may be fabricated using a variety of materials suitable for withstanding the temperatures and pressures associated with the repeated detonations. Such materials include but are not limited to: Inconel, stainless steel, aluminum, and carbon steel.

The impulse cleaning system 20 incorporating the first and the second impulse cleaning devices 22, 23 uses supersonic shock waves D that form cleaning energy E to loosen accumulated debris, deposits, and coatings that can accumulate on the vessel (e.g., boiler or other plant device). High-pressure fluid flow that follows the detonation helps blow the loosened material away from the cleaned surfaces. In operation, the impulse cleaning devices 22, 23 create a respective supersonic shock wave D and its associated high-pressure flow from a combustion cycle, which are phased to control their intersection point and repeated at high frequency. For example, in one embodiment, the impulse cleaning devices 22, 23 can operate at frequencies of less than 1 Hz up to or above 100 Hz; though, in other embodiments, the impulse cleaning devices 22, 23 can operate at any frequency. Each combustion cycle generally includes a fill phase, an ignition event, a flame acceleration into detonation or supersonic phase, and a blowdown phase.

A single occurrence of a fuel fill phase, a combustion ignition, an acceleration of the flame front to supersonic, and the blow down and purge of the combustion products will be referred to as “a combustion cycle” or “a detonation cycle.” The portion of time that the impulse cleaning system 20 is active is referred to as “cleaning operation.” Time when the vessel to be cleaned is being actively used for its purpose will be referred to as “boiler operation.” As noted above, the parts to be cleaned need not be part of a boiler vessel; however, for simplicity of reference, the term “boiler operation” will be used to refer to the operation of any vessel or other component being cleaned by the impulse cleaning system 20.

In the fill phase of the detonation cycle, air P and fuel F are fed into the impulse cleaning device 22. As shown in FIG. 1 and discussed above, pressurized air flow P (which may be a constant flow or may be a variable flow) is introduced into the combustion chamber 80 through the air inlet ports 66 and fuel F (which may be a constant flow or may be a variable flow) through the fuel inlet port 68. The fuel F and air flow P will mix to form a fuel/air mixture suitable for combustion within the impulse cleaning device 22. As more fuel and air are introduced and mixed, the combustion chamber 80 will tend to fill with the fuel/air mixture, starting near the closed head end 64 and proceeding along the length of the combustion chamber 80 as more fuel and air are introduced. Air flow P can be continuously fed to the impulse cleaning device 22 through the air inlet ports 66 during the cleaning operation.

In one embodiment, the valve 104 may be used to control the introduction of fuel F into the impulse cleaning device 22 by means of the controller 26. The air flow P may also be controlled for times when the impulse cleaning system 20 is not operating. According to one example embodiment, the controller 26 can track the amount of time that has passed since the opening of a fuel valve 104. Based upon the rate of air input to the impulse cleaning device 22, the controller 26 can close the fuel valve 104 once a sufficient amount of fuel F has been added so that the fuel/air mixture has filled the desired portion of the combustion chamber 80. The controller 26 then provides activation or ignition energy to the ignition device 120 in accordance with the implemented phasing profiles to control phased detonation of the impulse cleaning devices 22, 23.

The ignition device 120 is controlled to initiate the combustion of the fuel/air mixture within the combustion chamber 80. If, for example, a spark initiator is used as the ignition device 120, the controller 26 sends electrical current to the spark initiator to create a spark at a predetermined time, considering the phasing profiles. The phasing profiles provide the desired time delay between the ignition of the first impulse cleaning device 22 and the ignition of the second impulse cleaning device 23 to cause the desired lag in shock wave propagation. Aspects of the impulse cleaning system that can be considered as part of the controller logic and associated phasing profiles executed by the controller can include, but are not limited to, orientation of the first and the second impulse cleaning devices 22, 23 relative to each other (e.g., axial position around the vessel, distance between the two, relative angles, etc.), the fuel flow settings, the air flow settings, and the geometry of the respective combustion chambers (e.g., length, obstacles, diameter, etc.). The controller logic and phasing profiles are thus programmed to consider these variables to arrive at a desired ignition time delay between the two impulse cleaning devices 22, 23. It is appreciated that in other embodiments, operation parameters such as fuel flow and/or air flow may also be adjusted by the controller 26 in response to satisfying the desired phasing profiles.

In general, the ignition device 120 delivers sufficient energy into the mixture near the ignition device to form an expanding combustion front C in the fuel/air mixture. As this combustion front C consumes the fuel by burning it with the oxidizer present in the mixture, the combustion flame will propagate through the mixture within the combustion chamber 80. As the combustion front C propagates through the combustion chamber 80 of the impulse cleaning device 22, the combustion front will reach the walls of the body 60 and any obstacles that are disposed within the combustion chamber. The interaction of the combustion front C with the walls of the body 60 and the obstacles will tend to generate an increase in pressure and temperature within the combustion chamber 80. Such increased pressure and temperature tend to increase the speed at which the combustion front C propagates through the combustion chamber 80 and the rate at which energy is released from the fuel/air mixture by the combustion front. This acceleration continues until the combustion speed raises above that expected from an ordinary deflagration process in the deflagration zone a to a speed that characterizes a quasi-detonation or detonation in the detonation zone b. This deflagration to detonation process desirably takes place rapidly (in order to sustain a high cyclic rate of operation), and the obstacles may be used to decrease the run-up time and distance that is required for each initiated flame to transition into a detonation.

The detonation or supersonic shock wave D travels down the length of the body 60 and out of the horn end 62 as cleaning energy E. From the horn end 62, the cleaning energy E may be directed into the object to be cleaned, such as the vessel 40. High-pressure combustion products follow the supersonic shock wave D and flow through the horn end 62.

As the high-pressure products blow out of the impulse cleaning device 22, the continued supply of air flow P through the air inlet ports 66 will tend to push the combustion products downstream and out of the horn end 62. Such continued supply of air flow P is used to purge the combustion products from the body 60 of the impulse cleaning device 22. Once the combustion products are purged, the valve 104 for the fuel inlet port 68 is opened, and a new fill phase may be started to begin the next combustion cycle.

The impulse cleaning device 22 can be controlled by the controller 26 to produce multiple supersonic shock waves D in rapid succession. The supersonic shock wave D that exits from the horn end 62 includes an abrupt pressure increase, as cleaning energy E, that will impact the parts of the object to be cleaned such as the vessel 40. This cleaning energy E has several beneficial effects by breaking up accumulated debris and slag from the vessel 40 surfaces. In one aspect, the cleaning energy E can produce pressure waves that travel through and impact the accumulated slag and debris. Such pressure waves can produce flexing and compression within the accumulations that can enhance crack formation within the debris and break portions of the debris away from the rest of the accumulation, or from the vessel 40 surfaces. This is often seen as “dust” that is liberated from the surface of the accumulated slag.

Moreover, due to the opposed orientation (or any other orientation causing an intersection of the shock waves), the intersection of the shock waves (i.e., the cleaning energy E) creates an enhanced cleaning energy at the point of intersection due to the additive nature of the wave energy. Thus, the enhanced cleaning energy at the point of intersection between the shock wave propagating from the first impulse cleaning device 22 and the second impulse cleaning device 23 can be selectively directed to areas of the vessel by adjusting the ignition timing indicated by the phasing profiles.

In addition, the pressure change associated with the passage of the cleaning energy E can produce flex in the walls of the boiler itself, which can also assist in separating the slag from the vessel 40 surfaces. The repeated impacts from the cleaning energy E of the repeating combustion cycles may excite resonances within the slag that can further enhance the internal stresses experienced and promote the mechanical breakdown of the debris without damaging the components of the vessel 40 that have accumulated buildup. The repeated action of shock and purge is used to erode buildup that accumulates upon the vessel 40 surfaces.

Also shown in FIG. 1 is an optional sensor 24, which is used to sense the operational behavior of the relative impulse cleaning device 22 and transmit the sensor signal as operational feedback to the controller 26. The operational feedback can be used to provide data regarding combustor behavior, to monitor the health of the impulse cleaning system 20, to perform diagnostics, and/or to perform feedback for a cutoff circuit. In various embodiments, one or more sensors 24 may be, but are not limited to, a strain gauge, an accelerometer, an acoustic detection device, a pressure gauge, an ion probe, and the like. The sensor or sensors 24 may be mounted to the external surface of each impulse cleaning device 22, 23, within each impulse cleaning device 22, 23, or proximate each impulse cleaning device 22, 23. In other embodiments, one or more sensors may be associated with (e.g., mounted to or within) the vessel 40 for monitoring the shock wave behavior within the vessel 40 (e.g., to monitor the timing and/or location of the intersection events).

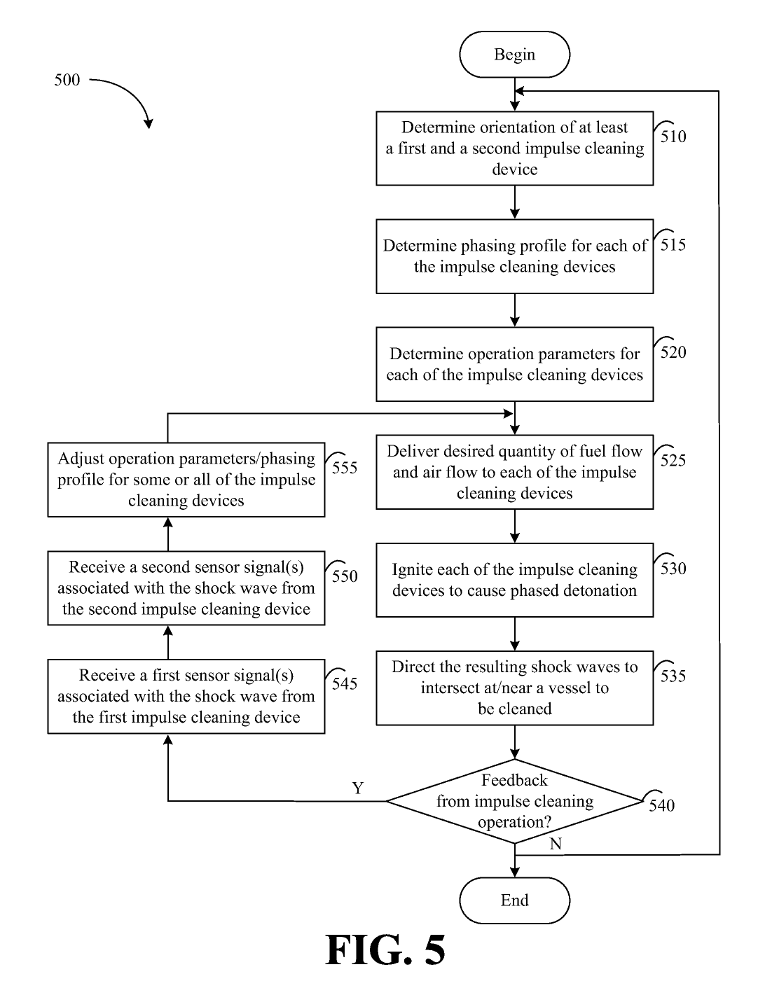

For example, each sensor 24 may generate a signal as feedback data that represents a function of the supersonic shock wave D in the impulse cleaning device 22, or in the vessel 40, such as its occurrence, its intensity, and relative timing. The controller 26 can use this information to control the delivery of fuel F to the combustion chamber 80, the delivery of pressurized air flow P to the combustion chamber, and/or the delivery of ignition energy to the ignition device 120. In addition, as illustrated in more detail with reference to FIG. 5, the controller 26 may use this operational feedback data to adjust the phasing profile and/or adjust the operational parameters to implement the desired phasing profile. Thus, the controller 26 receives the signal generated by the sensor 24 to control production of the supersonic shock wave D in response to the signal.

The output of the sensor 24 may be sent directly, without anti-alias filtering or other conditioning, to an analog-to-digital converter for any of the above-described uses (e.g., detecting the occurrence of the event, providing minimal delay to identify the start of detonation, determining the intensity level of the event, and/or frequency content of the event). However, in other embodiments, the output of the sensor 24 may be conditioned (filtered, amplified, etc.) in analog and/or digital form. The signal can have multiple uses, such as: detecting the occurrence of the detonation event; providing identification of the start of detonation; determining the intensity level of the event; determining frequency content of the event; and detecting of out-of-band frequency input.

FIGS. 2-4 illustrate example orientations of first and second impulse cleaning devices 22, 23 and the corresponding shock waves produced thereby. In FIG. 2, four stages of a phasing operation are illustrated in a cleaning system having opposed impulse cleaning devices 22, 23 oriented such that the shock waves propagated thereby travel along approximately the same axis toward each other. Accordingly, a point of intersection 210, 212, 214, 216 occurs where the two shock waves meet and generate an enhanced cleaning energy. As shown, the points of intersection move according to the phased operation of one of the impulse cleaning devices relative to the other. For example, the first pulse (Pulse 1) shows a point of intersection 210 nearer the first impulse cleaning device 22 because the second impulse cleaning device 23 was activated (e.g., ignited or otherwise operated) sooner than the first impulse cleaning device 22. The second pulse (Pulse 2) shows a point of intersection 212 close to the middle because both of the impulse cleaning devices 22, 23 were operated at or near the same time with no or very little intended delay provided. The third and fourth pulses (Pulse 3 and Pulse 4, respectively) show the points of intersection 214, 216 moving closer to the second impulse cleaning device 23 because the operation of the second impulse cleaning device 23 was delayed. The delay added during the fourth pulse is greater than the delay during the third pulse. Accordingly, in this example embodiment, a phasing profile is illustrated that provides a delay that moves the points of intersection along a section of a vessel with successive detonations.

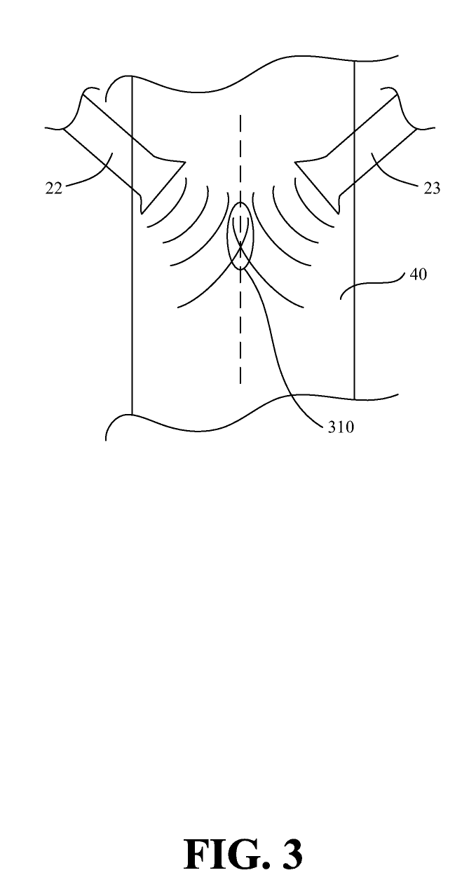

FIG. 3 illustrates another example orientation of an impulse cleaning system having two impulse cleaning devices 22, 23. In this embodiment, the first and the second impulse cleaning devices 22, 23 are also in opposed orientation, but arranged at an angled orientation to cause the corresponding shock waves point of intersection 310 to occur at an angle relative to each other. This permits directing the enhanced cleaning energy of the impulse cleaning devices 22, 23 to a point within the vessel 40 downstream or upstream of their placement.

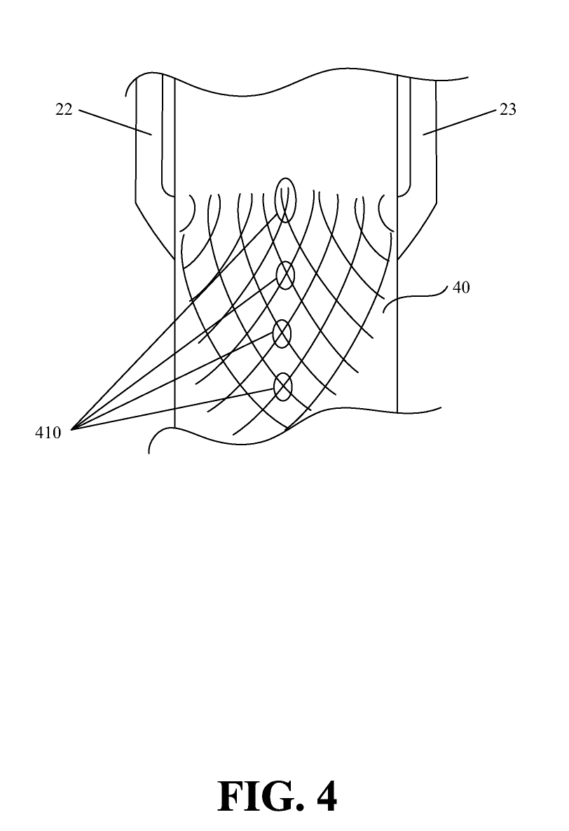

FIG. 4 illustrates yet another example orientation of an impulse cleaning system having two impulse cleaning devices 22, 23. In this embodiment, the first and the second impulse cleaning devices 22, 23 are oriented in a substantially parallel orientation with the vessel 40 positioned therebetween. Therefore, the corresponding shock waves propagate in approximately the same direction and approximately along the longitudinal axis of the vessel (e.g., along the length of a tube, etc.). Because of the radially dispersive pattern of shock waves, the point of intersection 410 in this orientation occurs at multiple points along the length of the vessel as is shown. The intersection nearer the impulse cleaning devices 22, 23 will likely generate a greater cleaning energy, but the intersection and additive effect will nonetheless continue to increase the cleaning energy generated at each point of intersection along the vessel 40.

It is appreciated that the impulse cleaning system configurations and device orientations illustrated and described with reference to FIGS. 2-4 are provided for illustrative purposes only, and that many other orientations can be provided.

FIG. 5 provides a flowchart of an example method 500 for providing phased detonation in an impulse cleaning system having multiple impulse cleaning devices. The controller and associated controller logic and other computer-executable instructions can, at least in part, be used to facilitate implementing the method illustrated hereby.

At block 510, the controller determines the orientation of the first and the second impulse cleaning devices. This determination may be done by accessing a previously stored device configuration profile in memory, or as a result of system operation and operational feedback provided from one or more sensors or other feedback generating mechanisms, as described above with reference to FIG. 1. The orientation of each impulse cleaning device is used to determine the approximated points of intersection of shock waves produced thereby, and also as factors in controlling other operational parameters (e.g., air, fuel, ignition timing, etc.). The orientation data may be any measurement, such as, but not limited to, radial location around a vessel, radial offset relative to other devices, distance from other devices, measured locations on the vessel, etc.

Following block 510 is block 515, in which the phasing profile is accessed by the controller. As described herein, the phasing profile may be used to indicate the desired location or locations of shock wave intersection points to deliver enhanced cleaning energies to the vessel at those points. Therefore, the phasing profile may also be provided as relative location on, in, or near the vessel to be cleaned, or as other measurements (e.g., distance from the respective impulse cleaning device, etc.), or the phasing profile may simply indicate a time delay (e.g., in milliseconds) having already considered the orientation of the impulse cleaning devices. The phasing profile may also indicate the number of pulses at each indicated intersection point.

Following block 515 is block 520, in which the operation parameters for each of the first and the second impulse cleaning devices are determined. Operation parameters may include, but are not limited to, the fuel flow, the air flow, the ignition spark, or the ignition timing, one or more of which may be determined based at least in part on the phasing profile.

After block 520 is block 525, in which the controller begins operation of each impulse cleaning device. In one example, beginning operation includes delivery of the desired quantity of fuel flow and air flow to the combustion chambers of each impulse cleaning device. Fuel flow and air flow rates and volumes can be controlled by the controller, either as part of implementing the phasing profile, and/or as independently determined operation parameters to accomplish the desired cleaning. As discussed above, the fuel flow and/or air flow or other operating parameters and behavior can further be monitored by the controller to permit analysis and consideration thereof when determining and implementing the phasing profile. For example, slight differences in the fuel/air mixture may affect the delay to be provided to accomplish the desired phasing profile.

Following block 525 is block 530, in which each of the impulse cleaning devices is independently operated (e.g., ignited) to implement the desired phasing profile. For example, the first impulse cleaning device may be operated prior to the second impulse cleaning device, the time difference being equal to a time delay indicated, or otherwise determined using the phasing profile. Phased operation (e.g., ignition and detonation) will cause the resultant shock waves to intersect closer to the later ignited impulse cleaning device due to the increased time of travel of the earlier ignited device, as is illustrated by block 535. As described above, other operational parameters of one or more of the impulse cleaning devices may be adjusted to implement the phasing profile (e.g., fuel flow, air flow, and/or ignition properties).

Direction of the shock waves to the vessel in block 535 can be accomplished by the orientation and/or the geometry of each of the impulse cleaning devices. Any of the above-described orientations (or any other orientation) that results in intersection shock waves may be provided. Moreover, the impulse cleaning devices may be externally affixed to the vessel, inserted into the vessel, or positioned in operable proximity of the vessel without direct contact.

Blocks 540-555 illustrate an optional operational feedback loop that can be implemented by an impulse cleaning system according to one embodiment. Operational feedback can be obtained from system sensors (e.g., sensors associated with the impulse cleaning devices and/or the vessel) during operation of the impulse cleaning devices. Operational feedback can include data indicating the timing of the combustion, the approximate point of intersection of the shock waves within the vessel, the intensity of the shock waves and/or enhanced cleaning energy created at the intersection, and the like.

Accordingly, if it is determined at decision block 540 that feedback is to be provided and/or considered, processing continues to block 545. At block 545, the controller receives one or more sensor signals from one or more sensors operably configured to sense information associated with the operation of the first impulse cleaning device. Similarly, at block 550, the controller receives one or more sensor signals from one or more sensors associated with the second impulse cleaning device. The sensors may be any electrical, mechanical, electromechanical, chemical, and/or electrochemical sensors, such as, but not limited to, those described above with reference to FIG. 1.

Following blocks 545 and 550 is block 555, in which the controller analyzes the received sensor signals and optionally makes adjustments to the operation parameters/phasing profile parameters to tune the operation of the impulse cleaning devices based on their actual operational behavior. For example, it may be that the time delay is to be adjusted because the shock wave intersection point does not occur at the desired location according to the phasing profile. Or, as another example, it may be determined that the intensity of the shock wave for one of the impulse cleaning devices is not the same as, or similar to, the other, and thus the fuel/air mixture can be adjusted to cause the shock wave intersection point to occur at the desired location.

After block 555, processing repeats to blocks 525-535 to operate each of the impulse cleaning devices under the altered control profile.

If, however, at decision block 540 it is determined that the system is not to consider any operational feedback, processing can return back to 510 for repeated cycles or end after block 540.

Accordingly, various embodiments described herein provide an impulse cleaning system having multiple phased impulse cleaning devices and associated methods of operating the same, which achieves the technical effects of intersecting shock waves within a vessel to be cleaned. Embodiments further achieve the technical effects of generating enhanced cleaning energies at the point of shock wave intersection, the location of which can be adjusted according to a predefined and/or alterable phasing profile. Therefore, these embodiments provide the ability to generate and deliver focused and tailorable cleaning energy within a vessel to improve cleaning thereof.

FIG. 6 illustrates a block diagram of an example controller 26, which may be used to at least partially carry out one or more of the methods described herein. More specifically, one or more controllers 26 may carry out the execution of the phased ignition and detonation of multiple impulse cleaning devices described herein. Each controller 26 may include a memory 605 that stores programmed logic 615, for example the controller logic and associated phasing profiles described above with reference to FIGS. 1-5, and may store data 620, such as operational feedback data, operational parameters, phasing profile data, historical operation data, and the like. The memory 605 also may include an operating system 625. A processor 610 may utilize the operating system 625 to execute the programmed logic 615, and in doing so, also may utilize the data 620. A data bus 630 may provide communication between the memory 605 and the processor 610. Users may interface with the controller 26 via a user interface device(s) 660, such as a keyboard, mouse, control panel, or any other devices capable of communicating data to and from the controller 26. The controller 26 may be in communication with one or more impulse cleaning devices, such as a single impulse cleaning device, multiple opposed impulse cleaning devices of an impulse cleaning system, or a network of impulse cleaning devices, some of which may operate independently of others in the network, via an input/output (I/O) interface 635. Though not shown, the controller 26 can comprise multiple controllers and/or can communicate with other memories and/or controllers for accessing distributed data and/or distributing processing and/or providing redundant processing. For example, each impulse cleaning device may be controlled by a different controller, wherein each controller is in operable communication (and optionally with one or more centralized controllers) to facilitate coordinating the phased ignition and detonation.

The application references block diagrams of systems, methods, apparatuses, and computer program products, according to at least one embodiment described herein. It will be understood that at least some of the blocks of the block diagrams, and combinations of blocks in the block diagrams, respectively, may be implemented at least partially by computer program instructions. These computer program instructions may be loaded onto a general purpose computer, special purpose computer, special purpose hardware-based computer, or other programmable data processing apparatus to produce a machine, such that the instructions which execute on the computer or other programmable data processing apparatus create means for implementing the functionality of at least some of the blocks of the block diagrams, or combinations of blocks in the block diagrams discussed in detail in the descriptions below.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the block or blocks.

One or more components of the systems and one or more elements of the methods described herein may be implemented through an application program running on an operating system of a computer. They also may be practiced with other computer system configurations, including hand-held devices, multiprocessor systems, microprocessor based, or programmable consumer electronics, mini-computers, mainframe computers, etc.

Application programs that are components of the systems and methods described herein may include routines, programs, components, data structures, etc., that implement certain abstract data types and perform certain tasks or actions. In a distributed computing environment, the application program (in whole or in part) may be located in local memory, or in other storage. In addition, or in the alternative, the application program (in whole or in part) may be located in remote memory or in storage to allow for circumstances where tasks are performed by remote processing devices linked through a communications network.

Many modifications and other embodiments of the exemplary descriptions set forth herein to which these descriptions pertain will come to mind having the benefit of the teachings presented in the foregoing descriptions and the associated drawings. Thus, it will be appreciated the invention may be embodied in many forms and should not be limited to the exemplary embodiments described above. Therefore, it is to be understood that the invention is not to be limited to the specific embodiments disclosed and that the modifications and other embodiments are intended to be included within the scope of the appended claims. Although specific terms are employed herein, they are used in a generic and descriptive sense only and not for purposes of limitation.

The claimed invention is:

1. A system for removing debris from a surface, comprising:
a first impulse cleaning device and a second impulse cleaning device, each impulse cleaning device generating shock waves directed at a surface to be cleaned, wherein the first impulse cleaning device and the second impulse cleaning device are oriented such that the respective shock waves intersect at or proximate the surface; and
a controller in operable communication with the first impulse cleaning device and the second impulse cleaning device, wherein the controller is configured to selectively cause phased operation of the first impulse cleaning device and the second impulse cleaning device such that the phased operation selectively controls the location of the intersection of the respective shock waves.

2. The system of claim 1, wherein the first impulse cleaning device and the second impulse cleaning device are oriented in an opposed orientation at least partially within a vessel.

3. The system of claim 2, wherein the opposed orientation of the first impulse cleaning device and the second impulse cleaning device cause the respective shock waves to propagate: (a) along approximately the same axis in opposite directions; or (b) to intersect at an angle relative to each other.

4. The system of claim 1, wherein the first impulse cleaning device and the second impulse cleaning device are oriented in a substantially parallel orientation at least partially within a vessel such that the respective shock waves propagate in approximately the same direction and approximately along the longitudinal axis of the vessel and intersect at one or more points along the length of the vessel.

5. The system of claim 1, wherein the first impulse cleaning device and the second impulse cleaning device each comprises a pulse combustion system comprising an oxidizer and an ignition device to ignite combustible fuel therein.

6. The system of claim 1, wherein the controller is further configured to selectively cause phased operation of the first impulse cleaning device and the second impulse cleaning device by delaying ignition of the second impulse cleaning device by a predetermined time relative to the ignition of the first impulse cleaning device.

7. A method for removing debris from a surface, comprising:
delivering a desired quantity of an oxidizer to a first impulse cleaning device and a desired quantity of an oxidizer to a second impulse cleaning device;
delivering a desired quantity of fuel flow to the first impulse cleaning device and a desired quantity of fuel flow to the second impulse cleaning device;
igniting the first impulse cleaning device and the second impulse cleaning device based at least in part on a phasing profile, thus causing phased operation of the first impulse cleaning device and the second impulse cleaning device such that the phased operation selectively controls the location of the intersection of corresponding shock waves produced by the first impulse cleaning device and the second impulse cleaning device; and
directing the corresponding shock waves towards a surface.

8. The method of claim 7, further comprising orienting the first impulse cleaning device and the second impulse cleaning device such that the corresponding shock waves produced thereby intersect at or near the surface.

9. The method of claim 7, wherein the first impulse cleaning device and the second impulse cleaning device are oriented in one of: (a) an opposed orientation causing the corresponding shock waves to propagate along approximately the same axis in opposite directions; (b) an opposed orientation causing the corresponding shock waves to intersect at an angle relative to each other; or (c) a substantially parallel orientation such that the corresponding shock waves propagate in approximately the same direction and approximately along the longitudinal axis of a vessel and intersect at one or more points along the length of the surface.

10. The method of claim 7, wherein the phasing profile is based at least in part on the orientations of the first impulse cleaning device and the second impulse cleaning device.

11. The method of claim 7, wherein the phasing profile is based at least in part on the fuel flow to the first impulse cleaning device and the fuel flow to the second impulse cleaning device.

12. The method of claim 7, wherein the phasing profile is based at least in part on the oxidizer flow to the first impulse cleaning device and the oxidizer flow to the second impulse cleaning device.

13. The method of claim 7, wherein the phasing profile is based at least in part on the geometry of the first impulse cleaning device and the geometry of the second impulse cleaning device.

14. The method of claim 7, further comprising:
receiving a first sensor signal associated with the shock wave produced by the first impulse cleaning device;
receiving a second sensor signal associated with the shock wave produced by the second impulse cleaning device; and
in response to an analysis of the first sensor signal and the second sensor signal, adjusting at least one of: (a) the delivery of the oxidizer to at least one of the first impulse cleaning device or the second impulse cleaning device; (b) the delivery of the fuel flow to at least one of the first impulse cleaning device or the second impulse cleaning device; (c) ignition timing for at least one of the first impulse cleaning device or the second impulse cleaning device; or (d) the phasing profile.

15. The method of claim 7, wherein the phased operation of the first impulse cleaning device and the second impulse cleaning device causes ignition of the first impulse cleaning device before ignition of the second impulse cleaning device causing the point of intersection of corresponding shock waves produced thereby to be more proximate the second impulse cleaning device relative to the first impulse cleaning device.

16. The method of claim 7, further comprising:
determining the orientation of the first impulse cleaning device; and
determining the orientation of the second impulse cleaning device.

17. The method of claim 7, wherein determining the orientation of the first impulse cleaning device and the second impulse cleaning device comprises reading from a memory the orientation of the first impulse cleaning device and the second impulse cleaning device relative to at least one of: (a) the surface to be cleaned, or (b) the respective other impulse cleaning device.

18. The method of claim 7, wherein directing the corresponding shock waves produced by the first impulse cleaning device and the second impulse cleaning device toward the surface to be cleaned is achieved in part by the orientation of the first impulse cleaning device and the second impulse cleaning device relative to the surface.

19. A system for removing debris from a surface, comprising:
a plurality of impulse cleaning devices, wherein at least two of the plurality of impulse cleaning devices are oriented such that respective shock waves produced thereby intersect at or proximate a surface to be cleaned; and
a controller in operable communication with the plurality of impulse cleaning devices, wherein the controller is operable to:
operate the plurality of impulse cleaning devices based at least in part on a phasing profile, thus causing phased operation of the at least two of the plurality of impulse cleaning devices such that the phased operation selectively controls the location of the intersection of respective shock waves produced by the first impulse cleaning device and the second impulse cleaning device.

20. The system of claim 19, wherein the at least two of the plurality of impulse cleaning devices are oriented in one of: (a) an opposed orientation causing the corresponding shock waves to propagate along approximately the same axis in opposite directions; (b) an opposed orientation causing the corresponding shock waves to propagate at an angle relative to each other; or (c) a substantially parallel orientation such that the corresponding shock waves propagate in approximately the same direction and intersect along the length of the surface.
